(19) United States
(12) Patent Application Publication
(10) Pub. No.: US 2012/0147419 A1
(43) Pub. Date: Jun. 14, 2012

(54) INFORMATION PROCESSING SYSTEM

(75) Inventors: Takuya Inoue, Kanagawa (JP); Shingo Ohta, Kanagawa (JP)

(73) Assignee: RICOH COMPANY, LTD., Tokyo (JP)

(21) Appl. No.: 13/300,778

(22) Filed: Nov. 21, 2011

(30) Foreign Application Priority Data
Dec. 13, 2010 (JP) 2010-277158

(51) Int. Cl. G06F 3/12

(52) U.S. Cl. 358/1.15

(57) ABSTRACT

An information processing system includes information processing devices and an accumulation device. Each information processing device includes a facsimile number acquisition unit that acquires a facsimile number registered in another information processing device; a number requesting unit that requests the accumulation device for a number corresponding to the facsimile number, the number including at least one of an area code, a country code, and an identification number of a telephone company, when the facsimile number does not include the number; and a facsimile transmission unit that attaches the number to the facsimile number and performs a facsimile transmission. The accumulation device includes a number return unit that returns a number corresponding to a facsimile number, the number including at least one of an area code, a country code, and an identification number of a telephone company, when the number is requested from one of the information processing devices.

### BACKGROUND OF THE INVENTION

1. Field of the Invention An aspect of this disclosure relates to a facsimile device, a printer, a scanner, a copier, and a multifunction peripheral; an information processing system including an information processing device, such as a personal computer; the information processing device that is included in the information processing system; an information processing method in the information processing device; and a program which causes a computer, the computer controlling an information processing device, to realize a required function.

2. Description of the Related Art

Information processing devices including a facsimile device, a printer, a scanner, a copier, a multifunction peripheral (these are also referred to as “image formation apparatuses”), and a personal computer may be used in such a manner that a FAX number of an another device is obtained from an external information processing device and a facsimile transmission with the other device is performed using the FAX number. Conventionally, there has been an information processing device such that, when a FAX number is obtained from a server and the FAX number includes an area code, and when the area code is unnecessary, the information processing device deletes the area code from the FAX number and performs a facsimile transmission (e.g. Patent Document 1 (Japanese Published Unexamined Publication No. 2004-282394)).

However, in a conventional information processing device, such as the information processing device described above, there has been a problem such that, when the area code is not attached to the FAX number of the other device obtained from the external information processing device, and when a line connection to a destination of the facsimile transmission is not established without the area code, a user may be required to perform complicated tasks of finding the area code and inputting the area code. An embodiment of the present invention has been developed in view of the above point. An objective of the embodiment is to enable a facsimile transmission using a FAX number without an area code that is registered in another device.

### SUMMARY OF THE INVENTION

In one aspect, there is provided an information processing system including a plurality of information processing devices and an accumulation device. The plural information processing devices and the accumulation device are mutually communicatively connected. Each of the plural information processing devices includes a registration unit that registers facsimile numbers of the other information processing devices; a facsimile number return unit that returns a first facsimile number from the registration unit, when the first facsimile number is requested from a first one of the other information processing devices; a facsimile number acquisition unit that requests a second one of the other information processing devices for a second facsimile number registered in the second one of the other information processing devices and that acquires the second facsimile number; a number requesting unit that requests the accumulation device for a number corresponding to the second facsimile number, the number including at least one of an area code, a country code, and an identification number of a telephone company, when the second facsimile number does not include the number; and a facsimile transmission unit that attaches the number to the second facsimile number and that makes a phone call to a destination of a facsimile transmission and performs the facsimile transmission, when the number corresponding to the second facsimile number requested with the number requesting unit is acquired. The accumulation device includes: an accumulation unit that stores numbers corresponding to the facsimile numbers of the plural information processing devices, each of the numbers including at least one of an area code, a country code, and an identification number of a telephone company; and a number return unit that returns one of the numbers corresponding to one of the facsimile numbers from the accumulation unit when the one of the numbers corresponding to the one of the facsimile numbers is requested from one of the plural information processing devices.

In another aspect, there is provided an information processing system in which there is a plurality of information processing devices, which devices are mutually communicatively connected. Each of the plural information processing devices is connectable to the Internet. Each of the plural information processing devices includes a registration unit that registers facsimile numbers of the other information processing devices; a facsimile number return unit that returns a first facsimile number from the registration unit, when the first facsimile number is requested from a first one of the other information processing devices; a facsimile number acquisition unit that requests a second one of the other information processing devices for a second facsimile number registered in the second one of the other information processing devices and acquires the second facsimile number; a connection unit that connects to a number search site on the Internet, when a number corresponding to the second facsimile number is not attached to the second facsimile number, wherein the number includes at least one of an area code, a country code, and an identification number of a telephone company; and a facsimile transmission unit that attaches the acquired number to the second facsimile number and that makes a phone call to a destination of a facsimile transmission and performs the facsimile transmission, when the number corresponding to the second facsimile number is acquired from the number search site connected using the connection unit.

In another aspect, there is provided an information processing system in which plural information processing devices are mutually communicatively connected. Each of the plural information processing devices includes: a registration unit that registers facsimile numbers of the plural information processing devices; a facsimile number return unit that returns a first facsimile number from the registration unit, when the first facsimile number is requested from a first one of the other information processing devices; a number return unit that returns a first number attached to a facsimile number of the information processing device itself, when the first number is requested from the first one of the other information processing devices, wherein the first number includes at least one of an area code, a country code, and an identification number of a telephone company; a facsimile number acquisition unit that requests a second one of the other information processing devices for a second facsimile number registered in the second one of the other information processing devices and acquires the second facsimile number; a number requesting unit that requests the second one of the other information processing devices for a second number attached to the second facsimile number, when the second number is not attached to the second facsimile number, wherein the second number includes at least one of an area code, a country code, and an identification number of a telephone company; a facsimile transmission unit that attaches the acquired second number to the second facsimile number and that makes a phone call to a destination of a facsimile transmission and performs the facsimile transmission, when the second number corresponding to the second facsimile number is acquired.

Other objects, features and advantages of the present invention will become more apparent from the following detailed description when read in conjunction with the accompanying drawings.

### BRIEF DESCRIPTION OF THE DRAWINGS

FIG. 1 is a diagram showing a configuration of an embodiment of an information processing system;

FIG. 2 is a diagram showing another example of the configuration of the information processing system;

FIG. 3 is a block diagram showing main components of a MFP shown in FIG. 1 and FIG. 2;

FIG. 4 is a block diagram showing main components of a server shown in FIG. 1;

FIG. 5 is a flowchart showing a process when the MFP 1 in FIG. 1 performs a facsimile transmission with the MFP 3;

FIG. 6 is a flowchart showing a process when the MFP 1 in FIG. 2 performs a facsimile transmission;

FIG. 7 is a flowchart showing a process when the MFP 1 in FIG. 1 or FIG. 2 performs a facsimile transmission.

### DETAILED DESCRIPTION OF THE PREFERRED EMBODIMENTS

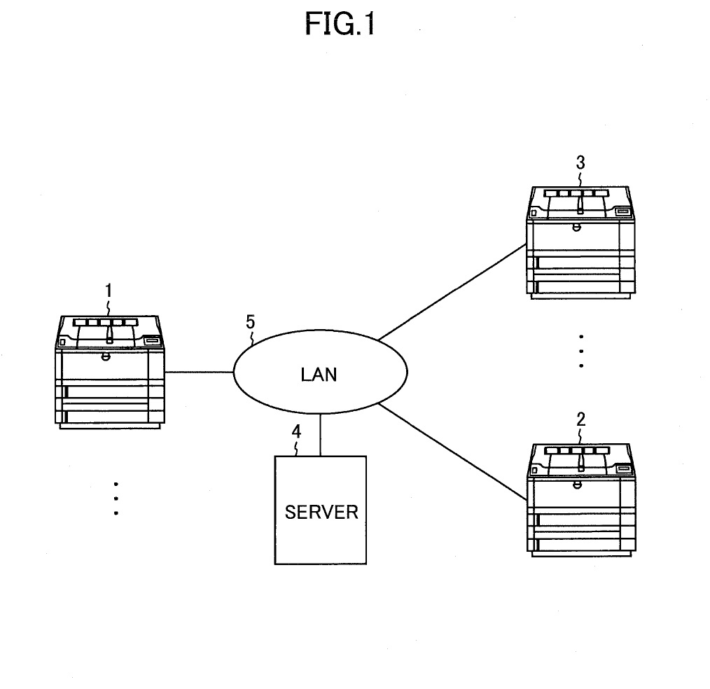

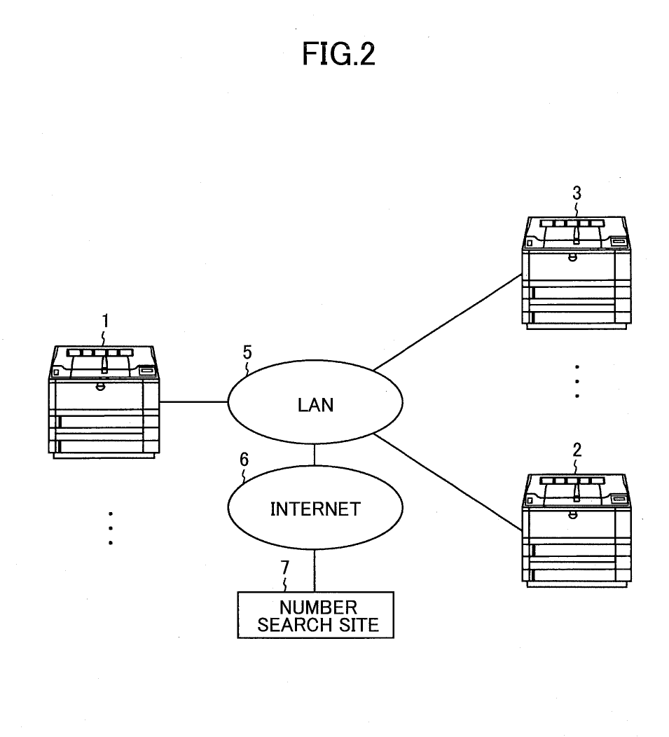

Hereinafter, an embodiment is explained concretely based on figures. FIG. 1 is a diagram showing a configuration of one embodiment of an information processing system. FIG. 2 is a diagram showing another example of the configuration of the information processing system.

In the information processing system shown in FIG. 1, units that are mutually communicatively connected through a LAN (Local Area Network) 5 include: plural MFPs (Multifunction Peripheral: MFP) 1-3 which are used by users; a server 4 which provides a number including at least one of an area code, a country code, or an identification number of a telephone company; an image formation apparatus, that is not shown in the figure, including a facsimile device, a printer, a scanner, and a copier; various types of devices, that are also not shown in the figure, including a personal computer (PC), a server as a database, and a print server; and an authentication server to authenticate users of corresponding devices.

In the information processing system shown in FIG. 2, units that are able to connect to the Internet 6 through the LAN 5, and are able to access a number search site 7 of the Internet 6 include: the MFPs 1-3; the image formation apparatus, that is not shown in the figure, including the facsimile device, the printer, the scanner, and the copier; and the various types of devices, that are also not shown in the figure, including the personal computer (PC), the server as the database, and the print server. Here, the number search site 7 is for searching for a number such as the area code, the country code, or the identification number of the telephone company.

The MFPs 1-3 correspond to the information processing device of the embodiment. The MFPs 1-3 are image formation apparatuses having plural functions including an image reading function (a scanner function), a printing function (a print function), a copying function (a copy function), a facsimile communication function (a FAX communication function), an e-mail communication function, and an image processing function.

The server 4 is a device that previously stores numbers corresponding to facsimile (FAX) numbers. Each of the numbers includes at least one of an area code, a country code, and an identification number of a telephone company. The server 4 returns a number corresponding to a FAX number in response to a request from any of the MFPs 1-3. The number search site 7 provides a service for searching for a number including at least one of an area code, a country code, and an identification number of a telephone company, published on the Internet 6. With the number search site 7, it is possible to search for the number corresponding to a destination of a FAX communication from one the MFPs 1-3, and the one of the MFPs 1-3 is able to obtain the number.

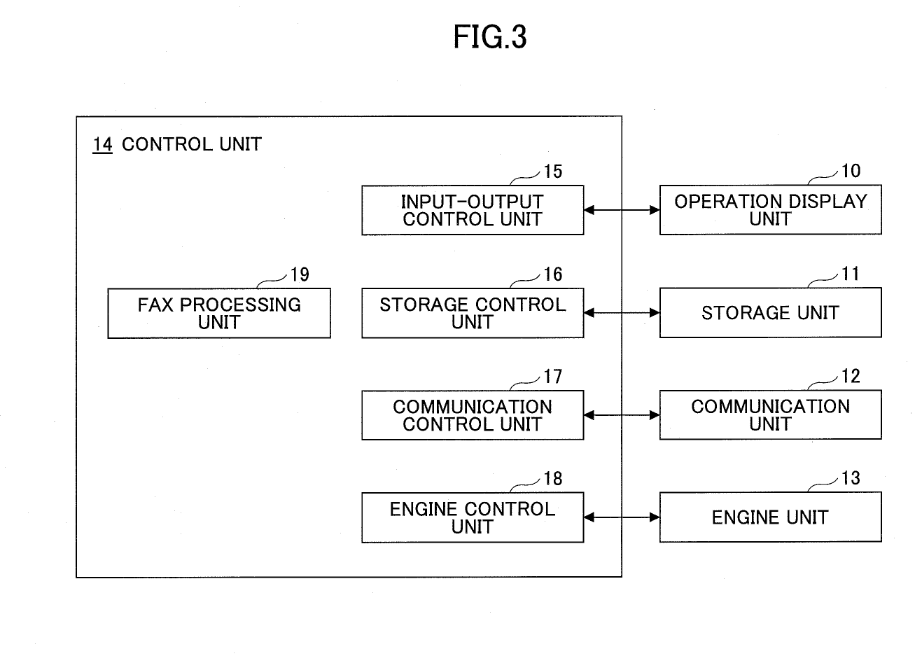

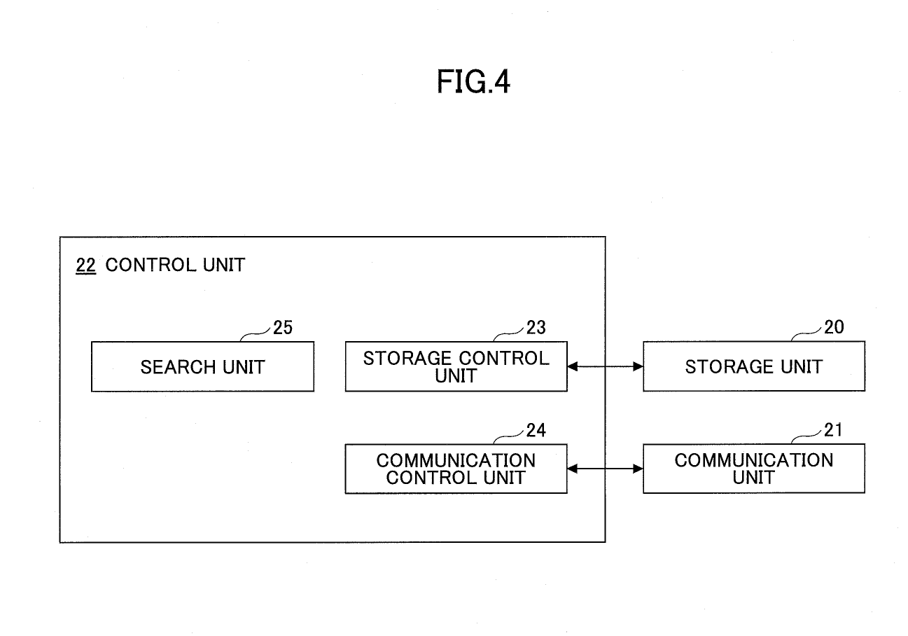

Next, main configurations of the MFPs 1-3 and a main configuration of the server 4 are explained. FIG. 3 is a block diagram showing the main configurations of the MFPs 1-3 shown in FIG. 1 and FIG. 2. FIG. 4 is a block diagram showing the main configuration of the server 4 shown in FIG. 1.

As shown in FIG. 3, each of the MFPs 1-3 in FIG. 1 and FIG. 2 includes an operation display unit 10, a storage unit 11, a communication unit 12, and an engine unit 13. The operations display unit 10 is an operation panel through which a user inputs various types of operating information. At the same time the operation display unit 10 is the operations panel that displays various types of information to the user. The storage unit 11 includes a hard disk drive (HDD) that stores various programs that are executed in the MFP and various types of data to be processed. The communication unit 12 handles data communications between the MFP and an external device through a LAN, a WAN, and the Internet and facsimile communications through communication lines including a public line. The engine unit 13 includes a scanner unit and a print unit.

FAX numbers for the MFP itself and various devices including other MFPs are registered in the storage unit 11. Namely, the storage unit 11 corresponds to a registration unit of the embodiment. In the embodiment, detailed explanations for the scanner unit and the print unit are omitted, since their internal configurations and capabilities are known in the art.

Each of the MFPs 1-3 of FIG. 1 and FIG. 2 includes a control unit 14 that controls the entirety of the corresponding MFP. The control unit 14 is realized by a microcomputer including a CPU, a ROM, and a RAM. The control unit includes an input-output control unit 15, a storage control unit 16, a communication control unit 17, an engine control unit 18, and a FAX processing unit 19. The input-output control unit 15, the storage control unit 16, the communication control unit 17, the engine control unit 18, and the FAX processing unit 19 are realized by the CPU when the CPU executes the programs (the programs include a program of the embodiment) stored in the ROM and the storage unit 11, while using the RAM as a working area, and executes various procedures (the procedures include procedures of the embodiment).

The input-output control unit 15 handles an input control process and a display control process with the operation display unit 10. The storage control unit 16 handles read/write controls for reading and writing data in the storage unit 11. The communication control unit 17 handles control of data communications and facsimile communications with the communication unit 12. The engine control unit 18 handles control of the scanner function, the print function, and the copy function with the engine unit 13.

The FAX processing unit 19 performs a process for a FAX communication with an external other MFP; a process for returning a FAX number registered in the MFP itself, the FAX number being requested externally; a process for obtaining a FAX number of a destination MFP from an external MFP, the FAX number not being registered in the MFP itself; a process for performing a facsimile transmission with the destination MFP; a process for obtaining a number including at least one of an area code, a country code, and an identification number of a telephone company from one of the external server 4, the number search site 7, the MFP from which the FAX number is obtained, and a user input which is input to the MFP itself, when the obtained FAX number does not include the number; and a process for performing a facsimile transmission while attaching the number to the obtained FAX number.

Namely, the FAX processing unit 19 functions as a FAX number returning unit, a FAX number acquisition unit, a number requesting unit, an access unit for accessing the number search site 7, and a FAX transmission unit.

The server 4 in FIG. 1 corresponds to an accumulation device of the embodiment. As shown in FIG. 4, the server 4 includes a storage unit 20 including a hard disk drive (HDD) that stores various types of program that are executed in the server 4 and various types of data including numbers, each of the numbers including at least one of an area code, a country code, and an identification number of a telephone company; and a communication unit 21 that handles data communications between the server 4 itself and the external MFPs 1-3 through the LAN 5. In the above storage unit 20, each of the numbers including at least one of the area code, the country code, and the identification number of the telephone company is stored while the number is associated with a local office number, namely, a subscriber number of the corresponding FAX number and an address and a name (a company name or an office name) of the destination of the FAX number, so that the number can be searched for. Namely, the above storage unit 20 functions as the accumulation unit of the embodiment.

The server 4 in FIG. 4 includes a control unit 22 that controls the whole server 4. The control unit 22 is realized by a microcomputer including a CPU, a ROM, and a RAM. The control unit includes a storage control unit 23, a communication control unit 24, and a search unit 25. The storage control unit 23, the communication control unit 24, and the search unit 25 are realized by the above-described CPU, when the CPU executes the programs stored in the ROM and the storage unit 20, while using the above described RAM as a working area, and executes various procedures.

The storage control unit 23 handles read/write controls for reading data from and writing data to the storage unit 20. The communication control unit 24 handles control of data communications with the communication unit 21. The search unit 25 searches for and returns a number, the number including at least one of an area code, a country code, and an identification number of a telephone company and being stored in the storage unit 20, based on data received from the MFPs 1-3, which are external devices. Namely, the search unit 25 functions as a number returning unit of the embodiment.

It is not indicated in the figure, but the server 4 may include a keyboard through which a user inputs various types of operating information; an input unit including a pointing device; and a display unit which is a display device including an LCD for displaying various types of information to the user.

Next, a FAX number acquisition process in the information processing system is explained. For example, when the MFP 1 in FIG. 1 performs a facsimile transmission with the MFP 3 in FIG. 1, and when a FAX number of the MFP 3 is not registered in an address book of the storage 11 of the MFP 1, the MFP 1 obtains the FAX number of the MFP 3 stored in an address book of the storage unit 11 of the MFP 2 using a cooperative processing function among MFPs in the information processing system. MFP 1 performs the facsimile transmission with the MFP 3 using the FAX number of the MFP 3, which is obtained from the MFP 2.

As a case in which an area code is not attached to the FAX number, for example, a case can be considered in which the FAX number of the MFP 3 not including the area code is stored in the address book of the storage unit 11 of the MFP 2. Note that when the MFP 2 and the MFP 3 are located in a same city, a line connection can be established by making a call to the destination using the FAX number which does not include the area code.

Here, a process is explained for a case in which the MFP 1 is located in a city in which the MFP 2 and the MFP 3 are not located, but both of the MFP 2 and the MFP 3 are located in a same city. Further, the FAX number of the MFP 3 obtained from the MFP 2 does not include the area code. Furthermore, the MFP 1 accesses the server 4 and obtains the area code corresponding to the FAX number of the MFP 3 from the server 4, and the MFP 1 attaches the area code to the FAX number of the MFP 3 and performs a facsimile transmission with the MFP 3 using the FAX number of the MFP 3, to which the area code is attached.

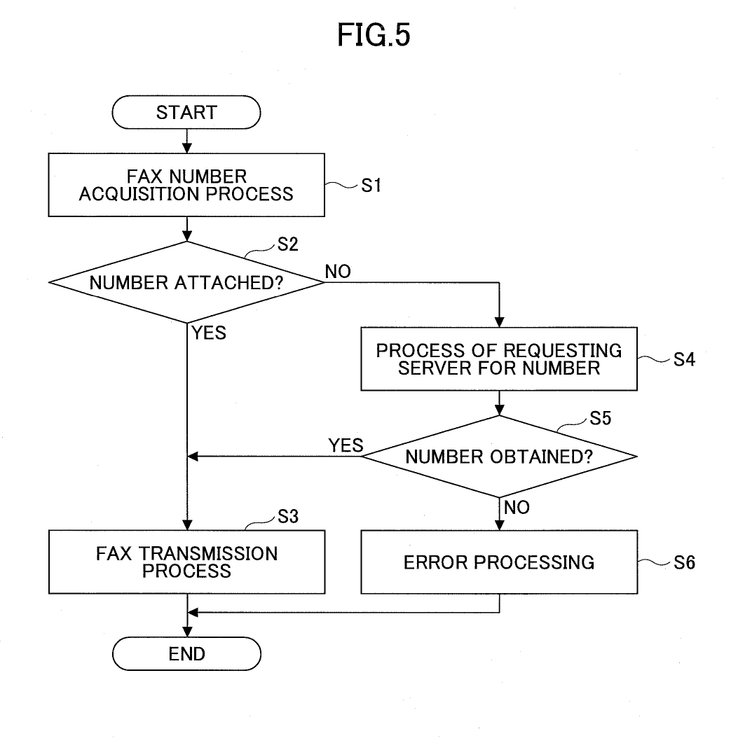

FIG. 5 is a flowchart showing a process when the MFP 1 in FIG. 1 performs a facsimile transmission with the MFP 3 in FIG. 1. When performing the facsimile transmission with the MFP 3, since the FAX number of the MFP 3 is not registered in the address book of the MFP 1 itself, the MFP 1 in FIG. 1 starts obtaining the FAX number of the MFP 3 from the MFP 2, in which the FAX number of the MFP 3 is registered.

The FAX processing unit 19 of the MFP 1 in FIG. 1 requests the MFP 2 for the FAX number of the MFP 3 and obtains the FAX number of the MFP 3 in the FAX number acquisition process at step (indicated by “S” in the FIG. 1 in FIG. 5, and proceeds to step 2. On the other hand, in the MFP 2 of FIG. 1, when the MFP 1 requests the MFP 2 for the FAX number of the MFP 3, the FAX processing unit 19 of the MFP 2 returns the FAX number of the MFP 3, the FAX number of the MFP 3 being registered in the storage unit 11 of the MFP 2.

The FAX processing unit 19 of the MFP 1 in FIG. 1 examines the FAX number of the MFP 3 obtained from the MFP 2 and determines whether an area code is attached to the FAX number of the MFP 3 in a determination process at step 2 of FIG. 5. When it is determined that the area code is attached to the FAX number of the MFP 3, the FAX processing unit 19 proceeds to step 3. The FAX processing unit 19 performs a facsimile transmission process with the MFP 3 using the FAX number of the MFP 3 obtained from the MFP 2. Then the FAX processing unit 19 terminates the process. However, when it is determined at step 2 that the FAX number of the MFP 3 obtained from the MFP 2 does not include the area code, the FAX processing unit 19 accesses the server 4 and requests the server 4 for the area code corresponding to the FAX number of the MFP 3 in a process at step 4. Then the FAX processing unit proceeds to step 5.

On the other hand, in the server 4 in FIG. 1, when the MFP 1 requests the server 4 for the area code corresponding to the FAX number of the MFP 3, the search unit 25 retrieves the area code corresponding to the FAX number of the MFP 3 among area codes corresponding to FAX numbers, the area codes being stored in the storing unit 20. When the area code is found, the search unit 25 returns the area code to the MFP 1. When the area code is not found, the search unit 25 notifies the MFP 1 of the absence of the area code. As a method for the MFP 1 to obtain a desired area code from the server 4, various methods can be considered using known techniques. For example, area codes and local office numbers within Japan may be associated and stored in the server 4 in advance. Then the server 4 may be configured such that, when the MFP 1 sends one of the local office numbers to the server 4, the server 4 returns the area code corresponding to the one of the local office numbers to the MFP 1.

Hereinafter, the process of obtaining the area code of the FAX number of MFP 3 from the server 4 is explained in detail for the case in which the FAX number of the MFP 3 is obtained by the MFP 1 from the MFP 2 and the area code is not included in the FAX number of the MFP 3. Further, it is assumed that both the MFP 2 and the MFP 3 are located in the same city. The storage unit 11 of the MFP 2 registers device-specific identification information (e.g. an identification number), which is attached to the MFP 2 in advance, or address information of an office where the MFP 2 is placed. Further, when the MFP 2 includes a GPS (Global Positioning System) receiver, the MFP 2 may return information about a location of the MFP 2, the location being determined with the GPS, in response to an external request.

Next, the server 4 stores at least one of the following in the storage unit 20 as customer information about all the MFPs on the LAN 5 including the MFPs 1-3: a database which associates, for all of the MFPs on the LAN 5 including the MFPs 1-3, the device-specific identification information of the MFP with the area code attached to the FAX number of the MFP; a database which associates, for all of the MFPs on the LAN 5 including the MFPs 1-3, the address information of the MFP with the area code attached to the FAX number of the MFP; and a database which associates, for all of the MFPs on the LAN 5 including the MFPs 1-3, the location information of the MFP with the area code attached to the FAX number of the MFP.

For example, in the method of obtaining the area code to be attached to the FAX number of the MFP 3 from the server 4 based on the device-specific identification information of the MFP 2, the FAX processing unit 19 of the MFP 1 requests the MFP 2 for the device-specific identification information, when it is determined at step 2 that the area code is not attached to the FAX number of the MFP 3 obtained from the MFP 2.

On the other hand, the FAX processing unit 19 of the MFP 2 reads out the device-specific identification information of the MFP 2 itself stored in the storage unit 11 and returns the device-specific identification information to the MFP 1 in response to the request from the MFP 1. When the FAX processing unit 19 of the MFP 1 receives the device-specific identification information from the MFP 2, the FAX processing unit 19 of the MFP 1 transmits the device-specific identification information obtained from the MFP 2 to the server 4 together with a request for the area code.

When the server 4 receives the request for the area code from the MFP 1, the server 4 retrieves the area code from the storage unit 20 based on the device-specific identification information which is transmitted together with the request for the area code. Then the server 4 reads out the area code corresponding to the device-specific information and returns the area code to the MFP 1. In this manner, the MFP 1 can obtain the area code of the FAX number of the MFP 2 from the server 4. The MFP 1 can attach the obtained area code to the FAX number of the MFP 3 obtained from the MFP 2. Here, the area code has not been attached to the FAX number of the MFP 3, because the MFP 3 is located in the same city as that of the MFP 2. After that, the MFP 1 can perform a facsimile transmission with the MFP 3 using the FAX number of the MFP 3, to which the area code is attached.

Cases that can be handled similarly to the above-described case include a case in which the MFP 1 obtains the area code of the FAX number of the MFP 2 from the server 4 based on the address information of the MFP 2; and a case in which the MFP 1 obtains the area code of the FAX number of the MFP 2 from the server 4 based on the information about the location of the MFP 2. When the address information of the MFP 2 is used, the MFP 1 can obtain the area code of the MFP 2 from the server 4, based on the address information of the MFP 2 that has been obtained by the MFP 1 from the MFP 2. When the information about the location of the MFP 2 measured with the GPS is used, the MFP 1 can obtain the area code of the MFP 2 from the server 4, based on the information about the location of the MFP 2 that has been obtained by the MFP 1 from the MFP 2.

Alternatively to the above-described processes, when the MFP 1 obtains the FAX number of the MFP 3 from the MFP 2, the process can be performed in the following manner. The MFP 1 asks the MFP 2 whether the area code is attached to the FAX number of the MFP 3. The MFP 2 examines and answers whether the area code is attached to the FAX number of the MFP 3 in response to the inquiry. When the MFP 1 receives the answer that the area code is not attached to the FAX number of the MFP 3, the MFP 1 may obtain from the MFP 2 as described above one of the device-specific identification information of the MFP 2, the address information of the MFP 2, and the information about the location of the MFP 2. Then the MFP 1 can obtain the area code of the MFP 2 from the server 4.

The FAX processing unit 19 of the MFP 1 in FIG. 1 proceeds to step 3, when it is determined that the requested area code corresponding to the FAX number of the MFP 3 has been obtained from the server 4 in a determination whether the number is obtained at step 5 in FIG. 5. Then the FAX processing unit 19 of the MFP 1 in FIG. 1 attaches the area code obtained from the server 4 to the FAX number of the MFP 3 obtained from the MFP 2, performs the facsimile transmission process with the MFP 3, and terminates the process. Further, when it is determined that the requested area code corresponding to the FAX number of the MFP 3 has not been obtained from the server 4 in the determination at step 5, the FAX processing unit 19 of the MFP 1 in FIG. 1 performs error processing to notify the user of an inability to perform the facsimile transmission because of the unknown area code of the FAX number at step 6.

For example, when the MFP 1 performs a facsimile transmission with the MFP 3 and the FAX number of the MFP 3 is not registered in the address book of the MFP 1, and when the FAX number “□□□-□□□□” of the MFP 3 is registered in the MFP 2, the MFP 1 obtains the FAX number “□□□-□□□□” of the MFP 3 from the MFP 2. Then the MFP 1 obtains the area code corresponding to the FAX number “□□□-□□□□” of the MFP 3, for example “046,” from the server 4. The MFP 1 can perform the facsimile transmission with the MFP 3 using the FAX number “046-□□□-□□□□”.

In this manner, when a facsimile transmission is performed using the cooperative processing function among the MFPs, and when the FAX number of the destination of the facsimile transmission is not registered in the address book of the MFP itself, the MFP can obtain the FAX number from another MFP. Further, even if the area code is not attached to the obtained FAX number, the MFP can obtain the area code registered in the external server, and the facsimile transmission can be performed by attaching the area code to the obtained FAX number. Therefore, a facsimile transmission based on an externally obtained FAX number can be ensured. Further, a user is not required to work on a complicated task, such as searching for an area code. Accordingly, the user's convenience is enhanced.

In the above described process, the case when the area code is obtained from the server 4 provided on the LAN 5 is explained. However, for the case of the information processing system shown in FIG. 2, the server 4 is not required, provided that the number search site 7 published on the Internet 6 is used. Therefore, an operational cost of the system can be reduced.

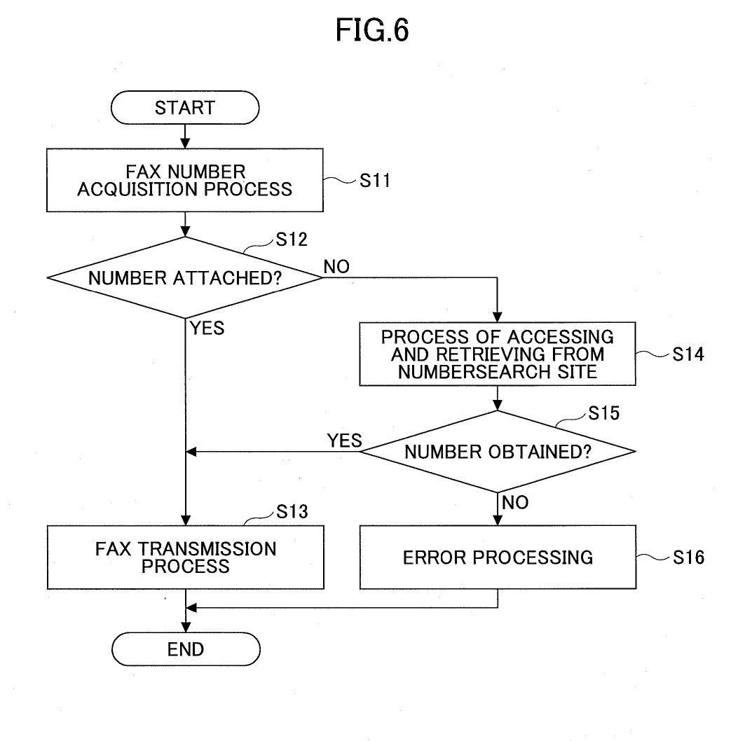

FIG. 6 is a flowchart illustrating the processes when the MFP 1 in FIG. 2 performs a facsimile transmission. When the MFP 1 in FIG. 2 performs a facsimile transmission with the MFP 3, since the FAX number of the MFP 3 is not registered in the address book of the MFP 1 itself, the MFP 1 starts obtaining the FAX number of the MFP 3 from the MFP 2 in which the FAX number of the MFP 3 is registered. The FAX processing unit 19 of the MFP 1 in FIG. 2 requests the MFP 2 for the FAX number of the MFP 3 and obtains the FAX number of the MFP 3 from the MFP 2 in a FAX number acquisition process at step (indicated by “S” in the FIGS. 11. Then the FAX processing unit 19 proceeds to step 12.

On the other hand, in the MFP 2 in FIG. 2, the FAX processing unit 19 of the MFP 2 returns the FAX number of the MFP 3 registered in the storage unit 11 when the FAX number of the MFP 3 is requested by the MFP 1. The FAX processing unit 19 of the MFP 1 in FIG. 2 examines and determines whether the area code is attached to the FAX number of the MFP 3 obtained from the MFP 2 in a determination process at step 12 in FIG. 6. When the area code is attached to the FAX number of the MFP 3 obtained from the MFP 2, the FAX processing unit 19 of the MFP 1 in FIG. 2 proceeds to step 13 and performs the facsimile transmission with the MFP 3 with the FAX number of the MFP 3 obtained from the MFP 2. Then the FAX processing unit 19 terminates the process.

However, when it is determined at step 12 that the area code is not attached to the FAX number of the MFP 3 obtained from the MFP 2, the FAX processing unit 19 of the MFP 1 in FIG. 2 accesses the number search site 7 on the Internet 6 in FIG. 2 and retrieves the area code corresponding to the above-described FAX number from the number search site 7 in a process of accessing and retrieving from the number search site, at step 14. Then the FAX processing unit 19 of the MFP 1 in FIG. 2 proceeds to step 15. In this manner, the latest area code can always be obtained, provided that an unknown area code is obtained using a number search site provided on the Internet. With this configuration, for example, when an area code corresponding to the area code registered on the server 4 is currently changed to another area code, it can be avoided that the area code externally obtained is not usable.

Hereinafter, the process of obtaining the area code of the FAX number of the MFP 3 from the number search site 7 on the Internet 6 is explained in detail for the case when the area code is not included in the FAX number of the MFP 3, which is obtained by the MFP 1 from the MFP 2. Here, it is assumed that both the MFP 2 and the MFP 3 are located in the same city. Similarly to the above description, the address information of the office where the MFP 2 is placed is stored in the storage unit 11 of the MFP 2 in advance. Further, the MFP 2 may be configured so as to return the location information of the MFP 2 measured with the GPS in response to an external request.

For example, in the method of obtaining the area code to be attached to the FAX number of the MFP 3 from the number search site 7 based on the address information of the MFP 2, the FAX processing unit 19 of the MFP 1 requests the MFP 2 for the address information, when it is determined at the above-described step 12 that the area code is not attached to the FAX number of the MFP 3 obtained from the MFP 2.

On the other hand, the FAX processing unit 19 of the MFP 2 reads out the address information of the MFP 2 itself stored in the storage unit 11 of the MFP 2 and returns the address information in response to the request from the MFP 1. When the FAX processing unit 19 of the MFP 1 receives the address information from the MFP 2, the FAX processing unit 19 of the MFP 1 accesses the number search site 7 on the Internet 6 based on an address (an address of the site) previously registered in the MFP 1 itself. Then the FAX processing unit 19 of MFP 1 transmits the address information obtained from the MFP 2 to the number search site 7 and obtains the area code. In this manner, the MFP 1 can obtain the area code of the MFP 2 from the number search site 7, and the MFP 1 can attach the obtained area code to the FAX number of the MFP 3. Here, the FAX number of the MFP 3 has been obtained from the MFP 2, and both of the MFP 2 and the MFP 3 are located in the same city. Then the MFP 1 can perform the FAX transmission to the MFP 3 using the FAX number of the MFP 3, to which the area code is attached. Additionally, similarly to the above-described case, a case can be handled in which the MFP 1 obtains the area code of the FAX number of the MFP 3 from the number search site 7 based on the location information of the MFP 2. In this case, the MFP 1 can obtain the area code of the MFP 2 from the number search site 7 based on the location information of the MFP 2 obtained by the MFP 1 from the MFP 2. Here, the location information of the MFP 2 is based on the measurement with the GPS.

Further, when the MFP 1 obtains the FAX number of the MFP 3 from the MFP 2, the following processes can be performed, instead of the above-described processes. The MFP 1 asks the MFP 2 whether the area code is attached to the FAX number of the MFP 3. The MFP 2 examines and answers whether the area code is attached to the FAX number of the MFP 3 in response to the inquiry. When the MFP 1 receives an answer that the area code is not attached to the FAX number of the MFP 3 from the MFP 2, the MFP 1 obtains the address information of the MFP 2 or the location information of the MFP 2 as described above, and retrieves the corresponding area code from the number search site 7.

When it is determined that the FAX processing unit 19 of the MFP 1 in FIG. 2 has searched for and obtained the area code corresponding to the above described FAX number through the number search site 7 in the determination on whether the number has been obtained or not at step 15, the FAX processing unit 19 of the MFP 1 in FIG. 2 proceeds to step 13 and attaches the area code obtained from the number search site 7 to the FAX number of the MFP 3 obtained from the MFP 2. Then the FAX processing unit 19 of the MFP 1 performs the facsimile transmission with the MFP 3 and terminates the process. Further, when it is determined in the determination at step 15 that the FAX processing unit 19 of the MFP 1 in FIG. 2 has searched for but has not obtained the area code corresponding to the FAX number of the MFP 3 from the number search site 7, the FAX processing unit 19 of the MFP 1 in FIG. 2 performs an error process to notify the user of an inability to perform the facsimile transmission because of the unknown area code of the FAX number.

In this manner, when the facsimile transmission is performed using the cooperative processing function among the MFPs, and when the FAX number of the destination of the facsimile transmission is not registered in the address book of the MFP itself, the MFP can obtain the FAX number from another MFP. Further, even if the area code is not attached to the obtained FAX number, the MFP can search for and obtain the unknown area code with a low cost by using the number search site provided on the Internet. Therefore, a facsimile transmission based on an externally obtained FAX number can be ensured.

Next, in the above described process, the case when the area code is obtained from the server 4 provided on the LAN 5 or the number search site 7 on the Internet 6 is explained. When both the MFP 2 and the MFP 3 are located in the same city, the area codes of the FAX numbers of the MFP 2 and the MFP 3 are the same (similarly for the case of the telephone numbers). Therefore, the area code of the FAX number (the telephone number) of the MFP 2 may be obtained from the MFP 2. Here, the area code of the FAX number of the MFP 2 is registered in the MFP 2, from which the FAX number of the MFP 3 has been obtained.

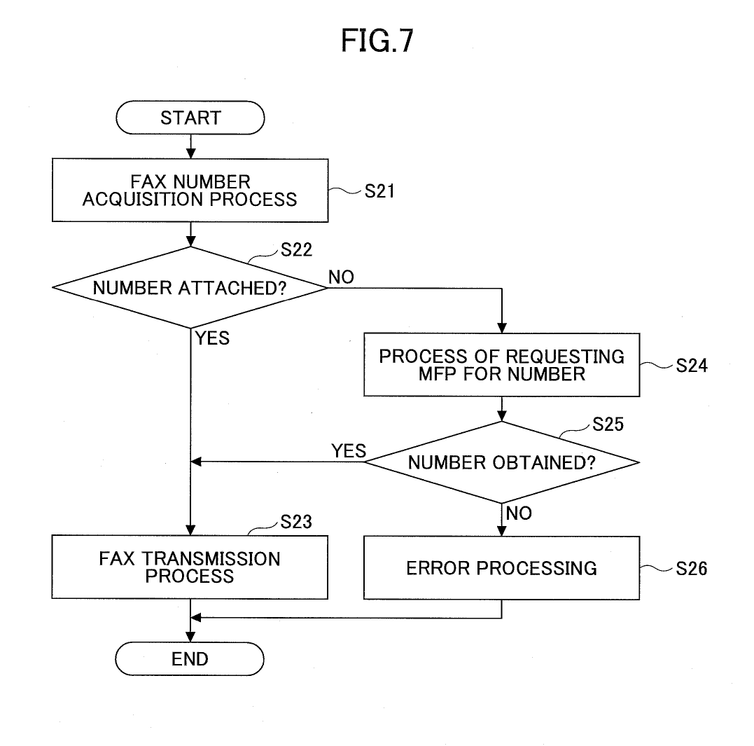

FIG. 7 is a flowchart illustrating the process when the MFP 1 of FIG. 1 or FIG. 2 performs the facsimile transmission with the MFP 3. When the MFP 1 of FIG. 1 or FIG. 2 performs the facsimile transmission with the MFP 3, since the FAX number of the MFP 3 is not registered in the address book of the MFP 1, the MFP 1 starts obtaining the FAX number of the MFP 3 from the MFP 2 in which the FAX number of the MFP 3 is registered.

The FAX processing unit 19 of the MFP 1 in FIG. 1 or FIG. 2 requests the MFP 2 for the FAX number of the MFP 3 and obtains the FAX number of the MFP 3 from the MFP 2 in a FAX number acquisition process at step (shown by “S” in the FIG. 21 in FIG. 7. Then the FAX processing unit 19 proceeds to step 22. On the other hand, in the MFP 2 in FIG. 1 or FIG. 2, when the MFP 1 requests the FAX processing unit 19 of the MFP 2 for the FAX number of the MFP 3, the FAX processing unit 19 of the MFP 2 returns the FAX number of the MFP 3 registered in the storage unit 11.

The FAX processing unit 19 of the MFP 1 in FIG. 1 or FIG. 2 examines the FAX number of the MFP 3 obtained from the MFP 2 and determines whether the area code is attached to the FAX number or not, in a determination process on whether the area code is attached at step 22 in FIG. 7. When the area code is attached to the FAX number of the MFP 3 obtained from the MFP 2, the FAX processing unit 19 of the MFP 1 in FIG. 1 or FIG. 2 proceeds to step 23 and performs the facsimile transmission with the MFP 3 using the FAX number of the MFP 3 obtained from the MFP 2. Then the FAX processing unit 19 of the MFP 1 in FIG. 1 or FIG. 2 terminates the process. However, when it is determined that the area code is not attached to the FAX number of the MFP 3 obtained from the MFP 2 in the determination at step 22, the FAX processing unit 19 of the MFP 1 in FIG. 1 or FIG. 2 accesses the MFP 2, from which the FAX number of the MFP 3 is obtained, in a process of requesting the MFP for the number at step 24. Then the FAX processing unit 19 of the MFP 1 in FIG. 1 or FIG. 2 requests the MFP 2 for the area code corresponding to the FAX number of the MFP 2 and proceeds to step 25.

On the other hand, in the MFP 2 in FIG. 1 or FIG. 2, when the MFP 1 requests the FAX processing unit 19 of the MFP 2 for the area code corresponding to the FAX number of the MFP 2, the FAX processing unit 19 of the MFP 2 extracts the area code from the FAX number of the MFP 2 itself, which is stored in the storage unit 20. Then the FAX processing unit 19 of the MFP 2 returns the extracted area code. When the area code is not attached to the FAX number of the MFP 2, the FAX processing unit 19 of the MFP 2 notifies the MFP 1 of the absence of the area code.

When it is determined that the FAX processing unit 19 of the MFP 1 in FIG. 1 or FIG. 2 has obtained the area code corresponding to the FAX number of the MFP 3 from the MFP 2 in a determination on whether the area code has been obtained at step 25, the FAX processing unit 19 of the MFP 1 in FIG. 1 or FIG. 2 proceeds to step 23. The FAX processing unit 19 of the MFP 1 in FIG. 1 or FIG. 2 attaches the area code obtained from the MFP 2 to the FAX number of the MFP 3 obtained from the MFP 2 and performs the facsimile transmission with the MFP 3. Then the FAX processing unit 19 of the MFP 1 in FIG. 1 or FIG. 2 terminates the process. Further, when it is determined that the FAX processing unit 19 of the MFP 1 in FIG. 1 or FIG. 2 has not obtained the area code from the MFP 2 in the determination at step 25, the FAX processing unit 19 performs, at step 26, error processing to notify the user of an inability to perform the facsimile transmission because of the unknown area code of the FAX number. Then the FAX processing unit 19 of the MFP 1 in FIG. 1 or FIG. 2 terminates the process.

Next, when the area code is not obtained from the above-described processes, or when the user who performs the facsimile transmission knows the area code, the area code may be directly input to the MFP 1, so that the area code is attached to the FAX number of the MFP 3 obtained from the MFP 2. In this manner, user convenience can be further enhanced.

When the FAX processing unit 19 of the MFP 1 in FIG. 1 or FIG. 2 confirms, after obtaining the FAX number of the MFP 3 from the MFP 2, that the area code is not attached to the FAX number of the MFP 3, the FAX processing unit 19 of the MFP 1 in FIG. 1 or FIG. 2 performs a process for obtaining the area code through any of the above-described processes. When the area code is not obtained through any of the above-described processes, the FAX processing unit 19 of the MFP 1 in FIG. 1 or FIG. 2 displays a work screen for inputting the area code corresponding to the FAX number of the MFP 3 on the operation display unit 10 using the input-output control unit 15. Then, when the area code is input to the work screen displayed on the operation display unit 10 and the area code is attached to the FAX number of the MFP 3, the FAX processing unit 19 of the MFP 1 in FIG. 1 or FIG. 2 performs the facsimile transmission with the MFP 3 based on the FAX number of the MFP 3, to which the area code has been attached.

Further, in the above-described embodiment, the cases in which the area codes are obtained from the outside are explained. Additionally, similarly to the above description, a case can be performed in which a FAX number includes at least one of an identification number, a telephone company number (an operator identification number, e.g. 0077 for KDDI (registered trademark)), and a country code (e.g. the country code of Japan, when making a phone call from a foreign country to Japan: 81). Here, the identification number is for making a domestic telephone call to designate a relaying telephone company.

Further, there is a possibility that a local office number has changed along with an area code. When a number including at least one of an area code, a local office number, a country code, and an identification number of a telephone company has been changed, the number may be replaced by obtaining the corresponding updated numbers through processes similar to the above-described processes. Further, in the above-described embodiment, the processes for the cases of the FAX numbers are shown. However, similar processes may be applied for e-mails. For example, when a domain name is abbreviated in an e-mail address, the abbreviated domain name is obtained and an e-mail can be transmitted by adding the domain name to the e-mail address.

The information processing system, the information processing device, the information processing method, and a program according to the embodiment may be applied generally to a facsimile device, a printer, a scanner, a copier, an image formation apparatus such as a multifunction peripheral, and an information processing device including a personal computer.

The present invention is not limited to the specifically disclosed embodiments, and variations and modifications may be made without departing from the scope of the present invention.

The present application is based on Japanese priority application No. 2010-277158 filed on Dec. 13, 2010, the entire contents of which are hereby incorporated herein by reference.

What is claimed is:

1. An information processing system comprising:
a plurality of information processing devices and an accumulation device, the plural information processing devices and the accumulation device being mutually communicatively connected, each of the plural information processing devices including
a registration unit configured to register therein facsimile numbers of the other information processing devices;
a facsimile number return unit configured to return a first facsimile number from the registration unit, when the first facsimile number is requested from a first one of the other information processing devices;
a facsimile number acquisition unit configured to request a second one of the other information processing devices for a second facsimile number registered in the second one of the other information processing devices and configured to acquire the second facsimile number;
a number requesting unit configured to request the accumulation device for a number corresponding to the second facsimile number, the number including at least one of an area code, a country code, and an identification number of a telephone company, when the second facsimile number does not include the number; and
a facsimile transmission unit configured to attach the number to the second facsimile number and configured to make a phone call to a destination of a facsimile transmission and to perform the facsimile transmission, when the number corresponding to the second facsimile number requested with the number requesting unit is acquired,
wherein the accumulation device includes
an accumulation unit configured to store therein numbers corresponding to the facsimile numbers of the plural information processing devices, each of the numbers including at least one of an area code, a country code, and an identification number of a telephone company; and
a number return unit configured to return one of the numbers corresponding to one of the facsimile numbers from the accumulation unit when the one of the numbers corresponding to the one of the facsimile numbers is requested from one of the plural information processing devices.

2. An information processing system in which a plurality of information processing devices are mutually communicatively connected, the plural information processing devices being connectable to the Internet, each of the plural information processing devices comprising:
a registration unit configured to register therein facsimile numbers of the other information processing devices;
a facsimile number return unit configured to return a first facsimile number from the registration unit, when the first facsimile number is requested from a first one of the other information processing devices;
a facsimile number acquisition unit configured to request a second one of the other information processing devices for a second facsimile number registered in the second one of the other information processing devices and configured to acquire the second facsimile number;
a connection unit configured to connect to a number search site on the Internet, when a number corresponding to the second facsimile number is not attached to the second facsimile number, wherein the number includes at least one of an area code, a country code, and an identification number of a telephone company; and
a facsimile transmission unit configured to attach the acquired number to the second facsimile number and configured to make a phone call to a destination of a facsimile transmission and to perform the facsimile transmission, when the number corresponding to the second facsimile number is acquired from the number search site connected using the connection unit.

3. An information processing system in which a plurality of information processing devices are mutually communicatively connected, each of the plural information processing devices comprising:
a registration unit configured to register therein facsimile numbers of the plural information processing devices;
a facsimile number return unit configured to return a first facsimile number from the registration unit, when the first facsimile number is requested from a first one of the other information processing devices;
a number return unit configured to return a first number attached to a facsimile number of the information processing device itself, when the first number is requested from the first one of the other information processing devices, wherein the first number includes at least one of an area code, a country code, and an identification number of a telephone company;
a facsimile number acquisition unit configured to request a second one of the other information processing devices for a second facsimile number registered in the second one of the other information processing devices and configured to acquire the second facsimile number;
a number requesting unit configured to request the second one of the other information processing devices for a second number attached to the second facsimile number, when the second number is not attached to the second facsimile number, wherein the second number includes at least one of an area code, a country code, and an identification number of a telephone company;
a facsimile transmission unit configured to attach the acquired second number to the second facsimile number and configured to make a phone call to a destination of a facsimile transmission and to perform the facsimile transmission, when the second number corresponding to the second facsimile number is acquired.

4. The information processing system according to claim 1, wherein each of the information processing devices further comprises:
an input unit configured to input the number to the information processing device so as to attach the number to the second facsimile number, when the number is not acquired.
